(19) United States
(12) Patent Application Publication
(10) Pub. No.: US 2015/0206222 A1
(43) Pub. Date: Jul. 23, 2015

(54) METHOD TO CONSTRUCT CONDITIONING VARIABLES BASED ON PERSONAL PHOTOS

(71) Applicant: Palo Alto Research Center Incorporated, Palo Alto, CA (US)

(72) Inventors: Evgeniy Bart, Sunnyvale, CA (US); Rui Zhang, San Francisco, CA (US); Robert R. Price, Palo Alto, CA (US); Oliver Brdiczka, Mountain View, CA (US)

(73) Assignee: Palo Alto Research Center Incorporated, Palo Alto, CA (US)

(21) Appl. No.: 14/160,211

(22) Filed: Jan. 21, 2014

(51) Int. Cl. G06Q 30/06

(52) U.S. Cl. CPC G06Q 30/0631

(57) ABSTRACT

One embodiment of the present invention provides a system for generating one or more recommendations for a customer. During operation, the system obtains transaction and image data for a plurality of existing customers. The system then trains one or more parameters of conditioning variables associated with one or more clusters based on image data as part of a predictive model. Next, the system determines a list of recommendable items for each cluster, based on the transaction data. The system obtains transaction and image data for a customer. The system then determines that the customer is a member of a cluster associated with the predictive model, based on the obtained transaction and image data. The system generates a recommendation for one or more recommendable items for the customer based on the determined cluster membership.

### BACKGROUND

1. Field

The present disclosure relates to recommendation systems. More specifically, this disclosure relates to a method and system for generating recommendations based on analyzing auxiliary data such as personal photos. This disclosure also relates to a method and system for generating intermediate variables to facilitate recommendations.

2. Related Art

As recommender systems become ubiquitous, customers routinely expect recommendations for products, information, coupons, and other materials. Companies use such recommendations to generate new revenue, to increase customer satisfaction, and to attract new and retain existing customers. A wide range of businesses can benefit from improved recommendation systems. These include video rental companies such as Netflix, advertising networks such as JiWire, mobile carriers trying to improve their customer experience such as AT&T, credit card companies such as Visa and Capital One, and various hotel groups.

Recommendation systems can use several types of information to make recommendations. This information can include a user's past selections of products or services (referred to as transaction data) and attributes of the product (e.g., color, size, weight). Other information can include correlations in product or service preferences derived from the population (e.g., collaborative filtering), and auxilliary information about users (e.g., age, gender, income, family status). Recommendation systems can obtain this information in several ways, including, for example, purchase records and symbolic information extracted from other sources (e.g., ratings, surveys, web pages)

Many recommender systems automatically organize customers into groups based on customers' past behavior. For example, one recommendation system uses customers' ratings of previously watched movies to recommend new movies. Another recommendation system asks users to upload photos of themselves in clothes they like and outline these clothes in the photos. The system then assigns the users to appropriate fashion groups.

A common feature of these methods is that they use primary data to determine the groups. Primary data is data that is directly related to the products or services being recommended. For example, the recommendation systems use information about previously watched movies to recommend movies, and use information about previously purchased products to recommend products. The use of primary data has several drawbacks. First, there is a “cold start” problem. Recommendation systems cannot reliably determine the appropriate group for new customers who do not have a sufficiently long record of past behaviors. As a result, recommendation quality suffers, which may cause the customer to opt out of the recommendations altogether. Second, it is often difficult to determine the appropriate groups based on primary data. For example, demographic attributes such as age, gender, and marital status influence customer preferences significantly. However, except in some special cases, it may be difficult to deduce them simply from movie ratings or past purchases.

Recently, some companies (e.g., Visa and Capital One) have started using auxiliary data from social network sites (in addition to the primary data about purchases) to improve customer grouping. Auxiliary data is data other than primary data. For example, some companies may use demographics information that is often readily available. In addition, using auxiliary data helps alleviate the cold start problem, because even customers new to a particular credit card are likely to have some information in their social network profile. However, the current use of auxiliary data is limited to analyzing text messages and social graphs of users.

### SUMMARY

One embodiment of the present invention provides a system for generating one or more recommendations for a customer. During operation, the system obtains transaction and image data for a plurality of existing customers. The system then trains one or more parameters of conditioning variables associated with one or more clusters based on image data as part of a predictive model. Next, the system determines a list of recommendable items for each cluster, based on the transaction data. The system obtains transaction and image data for a customer. The system determines that the customer is a member of a cluster associated with the predictive model, based on the obtained transaction and image data. The system generates a recommendation for one or more recommendable items for the customer based on the determined cluster membership.

In a variation on this embodiment, determining that the customer is a member of a cluster includes generating one or more intermediate variables; and predicting values of conditioning variables based on predicted values of the one or more intermediate variables.

In a variation on this embodiment, the system generates a recommendation based on membership in a single cluster, based on membership in a set of clusters, or based on a probability distribution over clusters.

In a variation on this embodiment, the system determines that a quantity of available transaction data for a new customer is below a predetermined threshold, and responsive to the determination, obtains image data for the customer to generate an item recommendation for the customer.

In a variation on this embodiment, the conditioning variables include one or more of product preference clusters, demographics-based clusters, activity preference clusters, or relationship-based clusters.

In a variation on this embodiment, the system generates one or more intermediate variables from image data and/or other auxiliary data, and trains the intermediate variables with transaction data as a supervision signal.

In a variation on this embodiment, the predictive model includes at least one of: generative decomposition of a joint distribution p(T, C, I, A)=p(C) p(I|C) p(A|I) p(T|C) such that the target variables are denoted by T, the conditioning variables are denoted by C, the intermediate variables are denoted by I, and the auxiliary data are denoted by A; or discriminative decomposition of a joint distribution P(T, C, I, A)=p(A) p(I|A) p(C|I) p(T|C).

### BRIEF DESCRIPTION OF THE FIGURES

FIG. 1 presents a block diagram illustrating a context of a system for facilitating a recommendation system, according to an embodiment.

FIG. 2 presents a block diagram illustrating a conceptual overview of predicting customer preferences from existing customer data, according to an embodiment.

FIG. 3 presents a block diagram illustrating a conceptual overview of generating intermediate variables from data, according to an embodiment.

FIG. 4 presents a flowchart illustrating an exemplary process for training a recommender, according to an embodiment.

FIG. 5 presents a block diagram illustrating exemplary clusters, according to an embodiment.

FIG. 6 presents a flowchart illustrating an exemplary process for applying the recommender, according to an embodiment.

FIG. 7 illustrates an exemplary computer system that facilitates a recommender, in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of generating recommendations for customers with limited or unavailable transaction histories by accessing customer photo data to generate recommendations with a predictive model. The system uses photos that customers produce and upload incidentally, during normal use of a social networking site. The consumers do not create or process the photos specifically for the recommendation system.

The recommendation system may use photo data (and other auxiliary data) to automatically predict one or more layers of intermediate variables of the predictive model. An intermediate variable is a variable that the system computes to facilitate recommendations. Intermediate variables can be, for example, a cluster that a customer is a member of, or the age or gender of the customer. A cluster is a group of customers with similar consumer patterns, such as people who take similar photos. The system can use transaction data as a supervision signal to train intermediate variables. The transaction data need not correspond directly to an intermediate variable. The system may use an intermediate variable to compute a conditioning variable or a target variable.

A conditioning variable is another variable that the system computes as part of the predictive model. Conditioning variables generally reflect consumer interests (e.g., “likes action movies” or “likes comedies”). In some implementations, the conditioning variable may indicate a discrete group to which a customer belongs. Depending on implementation, conditioning variables may be clusters. Some implementations may also include soft group assignments or interactions between groups (e.g., by using a regression on group membership rather than hard clustering). In hard clustering, each customer is placed definitively in a cluster, while in soft clustering each customer has a probability distribution over multiple clusters.

Identifying appropriate conditioning variables and estimating their values for customers is an important component of a recommender system. Computing conditioning variable values, such as by clustering customers and/or products, creates a simpler representation that can reduce inferential complexity. This also allows for generalizing across customers, since the learning preferences of some customers may help predict preferences of similar customers.

The system uses a conditioning variable only to compute a target variable. The system computes the target variable to determine whether a customer is expected to be interested in a particular product. The system predicts a value of the target variable in order to determine whether to recommend the product to a customer. For example, the target variable for the Netflix recommendation system is the rating (e.g., number of stars) that the system predicts the customer will give for a movie. In some cases, the target variable values are known for a subset of customers, but the system needs to predict target variable values for new customers or for new items for existing customers. The performance of a recommendation system depends on the accuracy of the target variable prediction.

The intermediate variables (or conditioning variables) can be clusters in various implementations. The system trains a recommender on cluster parameters. In one implementation, the recommender clusters customers based on their photo data. For example, one cluster may include people who have outdoor and nature pictures and no bar (or other alcohol consumption) pictures. Another cluster may include customers with both outdoor pictures and bar pictures. The system then analyzes the transaction history of the customers in the clusters to generate recommendation lists for each cluster. Note that some implementations may also predict intermediate variables based on transaction data, additional primary data, and/or other auxiliary data. Adding photos to the clustering process facilitates assignment of customers to clusters and improves the quality and prediction of clusters.

After training the recommender, the system then applies the recommender to generate predictions for customers. The system may collect a customer's photos and primary data. The system then assigns the customer to a cluster based on the customer's photos. When the system assigns a new customer to the cluster, the system generates one or more recommendations for the customer based on the recommendation lists. Some implementations may use photo data, primary data, other auxiliary data, and any combination of these data to cluster customers and assign customers to clusters. Some implementations may also assign a customer to multiple clusters. The system can generate a recommendation based on membership in a single cluster, a discrete set of clusters, or based on a probability distribution over clusters.

In some implementations, the conditioning variables can be used for applications other than recommendation. For example, some systems may use conditioning variables to determine groups of interest for market analysis, to suggest people with common interests to social network users, and to determine influencers in a network. Furthermore, some systems may use semi-supervised learning, where some intermediate variable instances are observed and others are unobserved. One may also use the techniques disclosed herein in more general applications to predict customer interest or predict customer behavior. For example, public transportation agencies may predict the number of customers that will ride a bus at a certain time in order to improve transportation planning.

### Analyzing Photos/Auxiliary Data

Personal photos provide an additional dimension of data that the system can use to generate recommendations. Photos tend to reflect the activities that people participate in. Photos provide more truthful information than text, since images are less subject to wishful thinking. Photos (and all images) provide information not available in text, such as age, gender, social status, activity preferences, and clothing style. Moreover, there is usually some correlation between the type of photos people take and their movie viewing patterns, product purchasing patterns, or other consumer patterns.

Personal photos provide a great amount of information that complements other media types such as social network posts or friend/follower graphs. Photos are tightly connected to the physical world and therefore represent parts of reality in a complete and accurate manner. In contrast, other media types may deviate from reality for a variety of reasons. One common reason for such deviation is the effort necessary to achieve an accurate representation. For example, a person's taste in clothing is very simple to illustrate using photos, while writing an elaborate textual description is much more difficult and therefore relatively rare. Another reason is that photos are less prone to wishful thinking or deliberate manipulation. For example, taking a photo together requires people to actually meet, while adding someone to their “friend list” is much easier and therefore potentially less indicative of the strength of the relationship.

The recommendation system can also extract from images information such as lifestyle, activity preferences, and demographics. The system can also improve recommendation results by combining image analysis with other types of auxiliary data available on the social networks, such as location/venue check-ins, demographic information, and text messages. Some implementations may incorporate auxiliary information to improve or optimize clustering results, while other implementations may simply cluster based on photo data. The system can refine the inference of intermediate variables (e.g., higher quality clusters) and improve the assignment of customers to clusters.

Incorporating auxiliary data into the clustering process requires no additional effort from customers since the system uses data that is already available. Moreover, auxiliary data provides information about features unavailable in primary data. For example, determining the number of people in a household based on movie watching data is non-trivial. It is much easier with social network data, and the information is often explicitly available.

Note that most currently available recommendation systems do not use images. This disclosure extends the state-of-the-art by using auxiliary images (e.g., not taken specifically for the purpose of using in a recommender system). Further, the techniques described herein require no manual processing.

### System Architecture

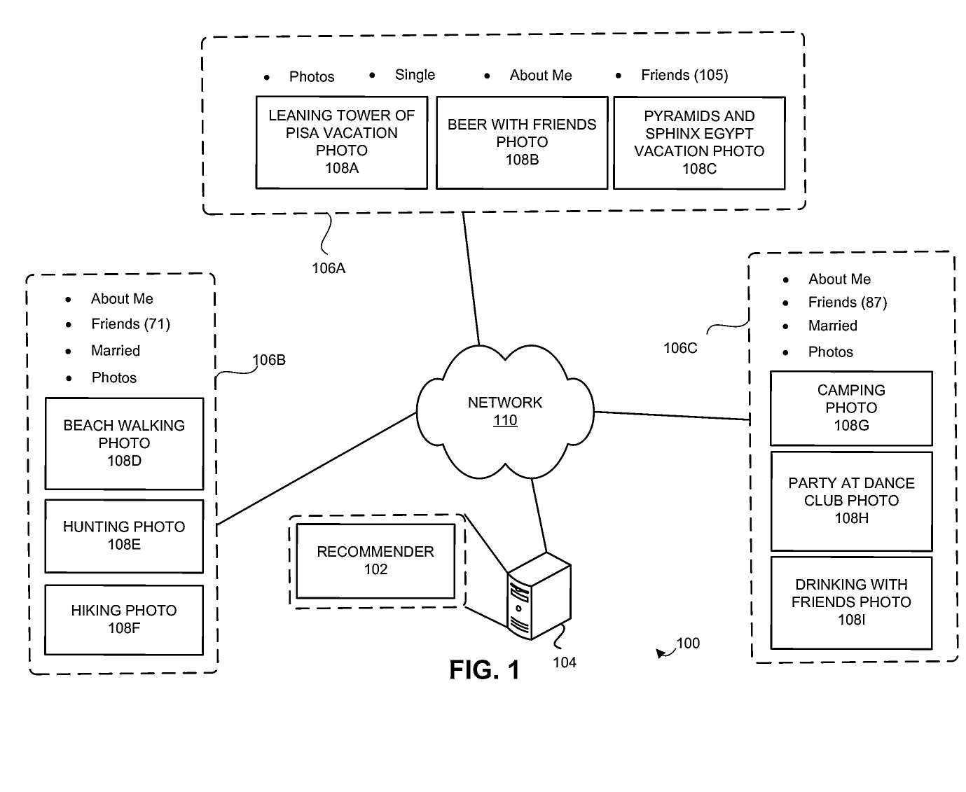

FIG. 1 presents a block diagram illustrating a context of a system 100 for facilitating a recommendation system, according to an embodiment. As illustrated in FIG. 1, system 100 may include a recommender 102 installed and running on a server 104. Server 104 in FIG. 1 may represent one or more servers.

System 100 obtains photo data and/or other auxiliary data from customers' social network profiles 106A-106C. As depicted in FIG. 1, system 100 may obtain photos 108A-108I through network 110 to train a recommender. After training the recommender, system 100 may apply the recommender to recommend items for customers. Note that system 100 can use the techniques described herein to recommend products, services, or any other recommendable items.

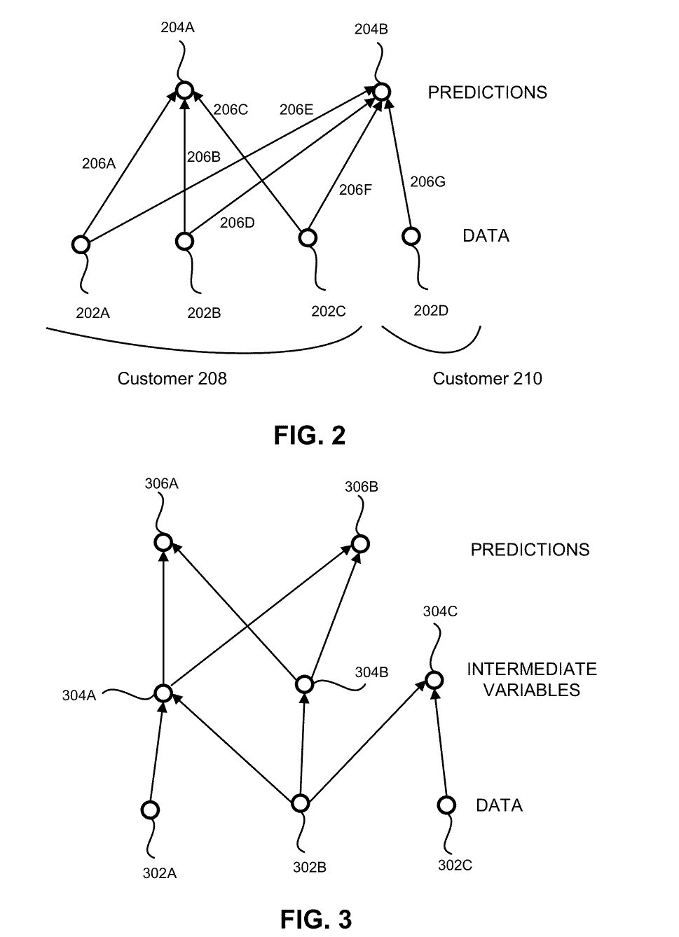

FIG. 2 presents a block diagram illustrating a conceptual overview of predicting customer preferences from existing customer data, according to an embodiment. System 100 can predict customer ratings for products that the customer has not yet tried. System 100 predicts customer interest in new products based on products that a customer may have tried and/or rated in the past. As depicted in FIG. 2, system 100 uses data (e.g., represented by nodes 202A-202D) to predict whether a customer will like certain products (e.g., predictions represented by nodes 204A-204B).

Nodes 202A-202D may represent existing data indicating whether a customer likes a particular product. For example, nodes 202A-202C may represent movies that customer 208 has viewed and rated. Nodes 204A-204B may represent products that customers have not yet purchased but that system 100 may recommend. For example, node 204A may represent a movie that customer 208 has not yet seen and/or rated. Edges 206A-206G indicate that system 100 is predicting the customers would like the products (e.g., nodes 204A-204B) that they have not previously tried. In FIG. 2, the previously rated movies are grouped according to customer. Nodes 202A-202C are associated with customer 208, and node 202D is associated with customer 210. Note that besides recommending products, system 100 can also recommend services or any other recommendable items. Generating the predictions may involve several processing stages, including training intermediate variables, which is discussed further with respect to FIG. 3.

FIG. 3 presents a block diagram illustrating a conceptual overview of generating intermediate variables from data, according to an embodiment. As illustrated in FIG. 3, system 100 uses data (e.g., nodes 302A-302C) to generate intermediate variables (e.g., nodes 304A-304C), and then generates predictions (e.g., nodes 306A-306B) from intermediate variables (e.g., nodes 304A-304B). Note that system 100 may also generate conditioning variables (not illustrated) from intermediate variables, and then generate the product predictions from the conditioning variables.

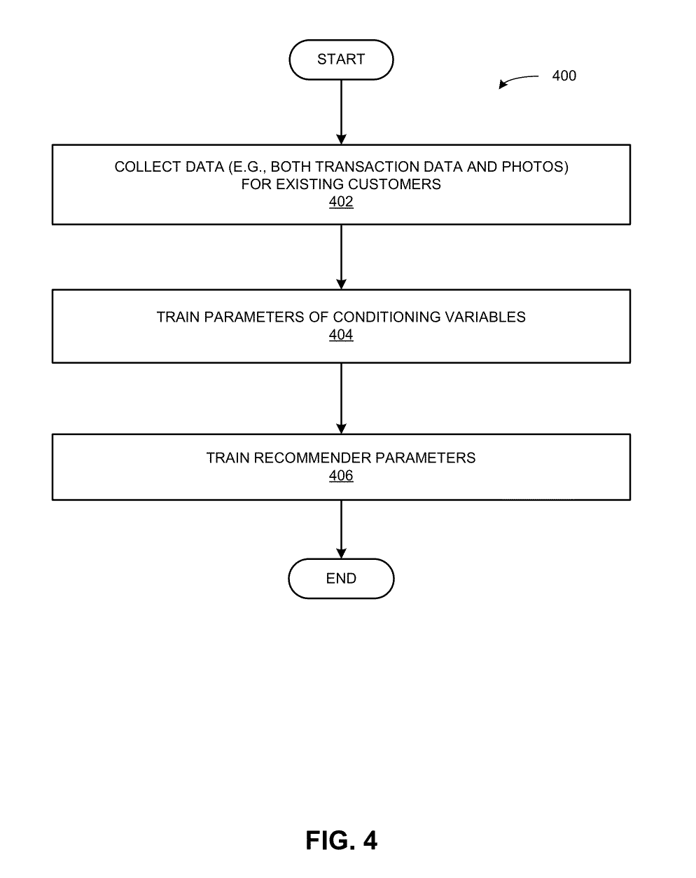

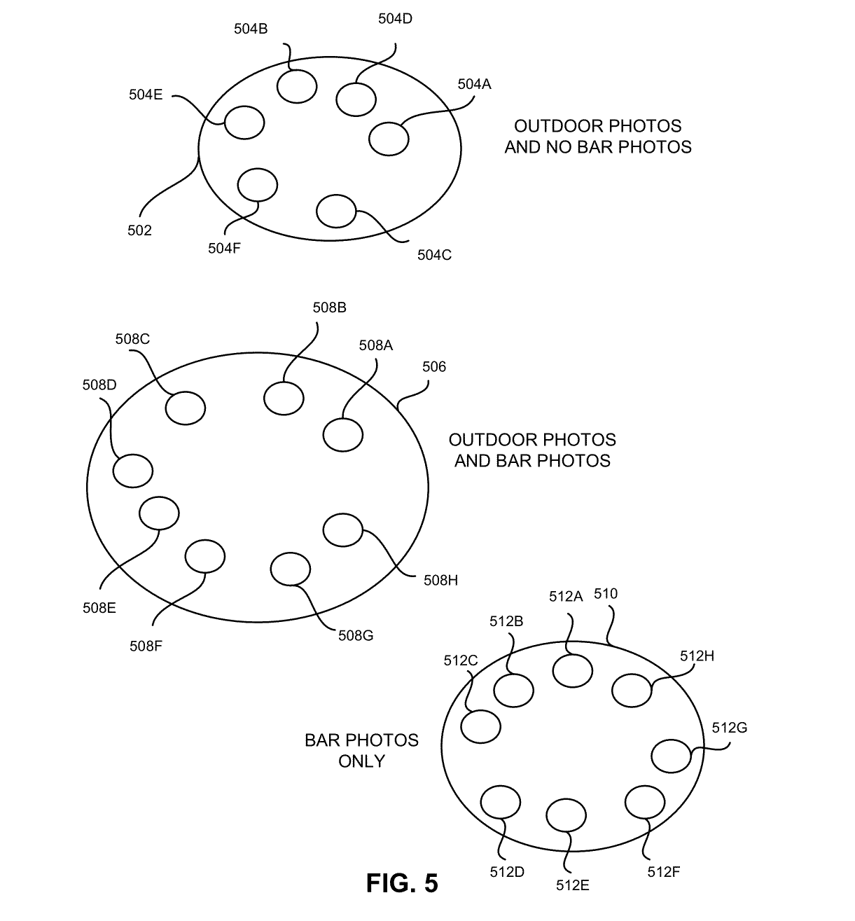

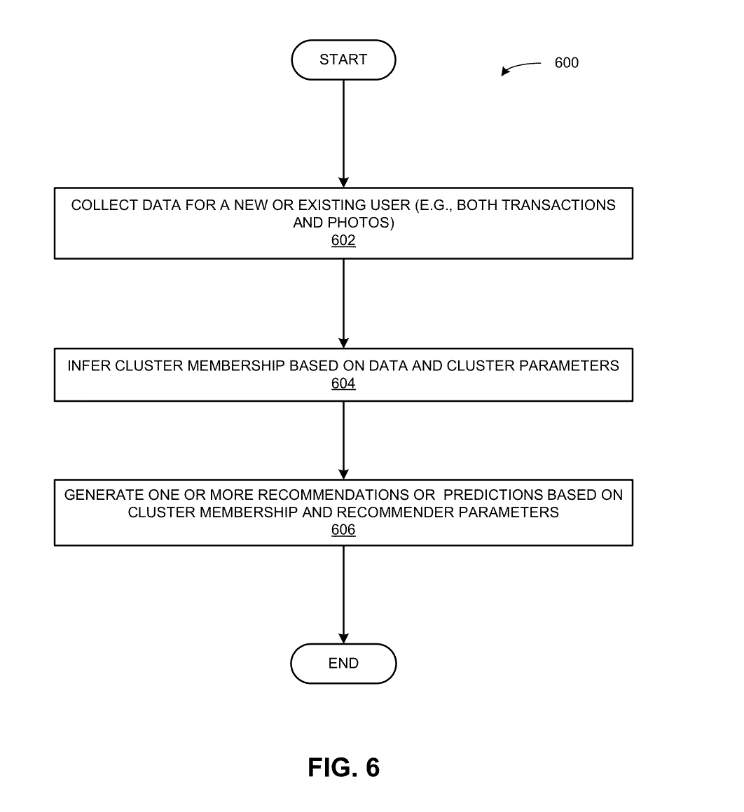

FIG. 4 and the accompanying text illustrates and describes how to train the recommender to identify customer clusters. FIG. 5 and the accompanying text illustrates and describes a set of clusters. FIG. 6 and the accompanying text illustrates and describes how to generate recommendations with the clusters.

### Training a Recommender

FIG. 4 presents a flowchart illustrating an exemplary process for training a recommender, according to an embodiment. During the training process, system 100 analyzes photos to generate clusters of customers with similar photos. System 100 identifies clusters, determines the parameters of the clusters, and labels the clusters. For example, system 100 may identify and label a cluster as having customers that like to take outdoor photos but do not take photos while drinking in bars. System 100 then determines a list of recommendable items for each cluster based on transaction data associated with the customers in their respective clusters.

Initially, system 100 collects data (e.g., both transaction data and photos) for existing and new customers (operation 402). System 100 uses the information to identify clusters. System 100 may ask customers to opt in to a service that collects information from social networks. System 100 may harvest data from the social network, including images and other available data such as text messages, demographic information, and friend lists. In some implementations, system 100 may combine auxiliary social network data with available primary data (such as credit card transactions, movie ratings, location visits, etc.) to infer the appropriate customer clusters.

Photos can also be uploaded by customers voluntarily, automatically uploaded as they are captured (e.g., by a cell phone), or extracted from other multimedia messages. System 100 can combine images and text from multiple auxiliary data sources, such as from several social networking sites. Note that system 100 can also use data other than photo images (e.g., video or audio). In some implementations, transaction data includes the movies that customers have viewed, location check-in data, or any other types of data.

Next, system 100 trains parameters of conditioning variables (operation 404). For example, the conditioning variables may be clusters, and system 100 trains the parameters of the clusters.

System 100 can extract features, learn features from lower-level features, and classify photos collected for each customer. System 100 can apply computer vision algorithms to detect scenery, people, background, and other objects in photos. System 100 can extract simple features such as color and texture. System 100 can also extract complex, higher-level features such as presence, identity, and number of faces in an image, scene setting (e.g., indoors/outdoors), and social occasion (e.g., party or family outing).

System 100 can extract counts of individual words for text messages. For transaction data, system 100 can extract a record of items the customer showed interest in (e.g., customer's purchased products or highly ranked movies). For location check-ins, system 100 can infer activities associated with each location (and each image) using check-in semantics available from location-based social networks such as Foursquare.

System 100 then applies standard classifiers to classify the photos according to a number of predetermined categories. For example, there can be 100 categories of photos, including categories such as pets, landscapes, nature scenes, social events, and sporting events.

System 100 can then determine the distribution and/or generate a histogram of the photo classifications for each customer. For example, a customer may have 50% outdoor photos, 40% travel photos, and 10% drinking and party photos. In some implementations, system 100 can also analyze and generate distributions and/or histograms for primary data (e.g., movies viewed or products purchased).

After determining the distribution and/or histograms, system 100 then clusters the customers according to their distributions and/or histograms. System 100 may use a clustering algorithm such as k-means or other standard clustering algorithms for recommender systems. In one implementation, system 100 associates each customer with a vector of numbers (e.g., the customer's distribution and/or histogram) mapped to a point in n-dimensional space. System 100 can assign customers (e.g., points in n-dimensional space) that are within a predetermined distance of each other to the same cluster. The clusters can be disjoint or overlapping. Each customer can be associated with a single cluster or a set of clusters, depending on implementation.

System 100 may also label the clusters. For example, system 100 can label a cluster as having customers that have outdoor photos with no bar photos (e.g., no photos of the customer drinking at a bar). System 100 can label a second cluster as having customers that have both outdoor photos and bar photos. System 100 can label a third cluster as having customers with only bar photos. Some examples of clusters and their labels are described with respect to FIG. 5.

Note that some implementations may include soft clusters, overlapping clusters, or other types of conditioning variables. The conditioning variables may also include product preference clusters, demographics-based clusters (e.g. age, gender, household income, number, ages, and genders of children), activity preference clusters (e.g. outdoors vs. indoors), and clusters based on relationships between people (e.g., friendship, family ties, common interests).

System 100 subsequently trains recommender parameters (operation 406). System 100 associates each cluster with a set of products or services. The set of products or services is referred to as a recommendation list. System 100 associates one or more recommendations lists with each cluster. System 100 can determine these products or services by analyzing past transaction data of the customer members of each cluster. The customers assigned to a cluster have similar tastes or preferences. System 100 can recommend products or services based on the products or services that others in the cluster have also purchased or enjoyed.

By clustering customers with similar photo distributions and/or histograms together, system 100 can generate recommendations for these customers. The customers in the same cluster are likely to have a similar taste in movies. For example, if a customer likes to watch The Wizard of Oz and Citizen Kane and another person in the same cluster likes to watch It's a Wonderful Life, then system 100 can predict that other customers within the same cluster also likes to watch these movies, and generate recommendation lists accordingly.

Some implementations may associate each product or service in a recommendation list with a probability of recommendation. System 100 may determine the probability of recommendation based on the number of customers in the cluster that have purchased or enjoyed the product or service. For example, system 100 may generate a recommendation list that includes Die Hard and The Godfather. Die Hard may have a higher likelihood of being recommended than The Godfather because there are more people in the cluster that watched Die Hard.

FIG. 5 presents a block diagram illustrating exemplary clusters, according to an embodiment. As depicted in FIG. 5, cluster 502 includes points 504A-504F representing customers that have outdoor photos with no bar photos. Cluster 506 includes points 508A-508H representing customers that have both outdoor photos and bar photos. Cluster 510 includes points 512A-512H presenting customers with only bar photos. Note that the clusters can be disjoint or overlapping.

### Intermediate Variables

A significant problem with auxiliary data is that it is often unclear how to use it for prediction. Using auxiliary data to directly predict the target variable or the conditioning variables often works poorly because they represent very different concepts. Bridging this gap in one step is difficult. It is therefore desirable to construct another set of variables, the intermediate variables, to facilitate the prediction.

System 100 may use a latent-variable model with unobserved intermediate variables. System 100 uses the auxiliary data to predict the types and values of the intermediate variables, and then system 100 uses the intermediate variables to predict the conditioning variables. During training, system 100 automatically infers intermediate variables appropriate for a given task. System 100 can use transaction data as a supervision signal to facilitate the inference. System 100 may also use traditional training data if available. System 100 may use transaction data both to infer appropriate intermediate variables and to train the intermediate variables when training data is unavailable or scarce. Note that intermediate variables can be semantically meaningful but some are not.

Several ways to infer intermediate variables are possible. In particular, one may use generative or discriminative models. Denoting the target variables by T, the conditioning variables by C, the intermediate variables by I, and the auxiliary data by A, the following generative decomposition of the joint distribution p(T, C, I, A) is possible: p(T, C, I, A)=p(C) p(I|C) p(A|I) p(T|C). Here A is observed, T is observed for some customers and items and needs to be predicted for others, C is unobserved, and I is generally unobserved. Note that if one designates a subset of intermediate variables manually, such as demographics variables, and a training set is available, then I can be observed for a subset of the data. One can specify appropriate parametric or non-parametric conditional distributions, and system 100 can perform inference using standard methods (e.g., Gibbs sampling).

One may also decompose the same joint distribution discriminatively as follows: P(T, C, I, A)=p(A) p(I|A) p(C|I) p(T|C). In this case, one can also give the conditional distribution an appropriate parametric or non-parametric form (e.g., logistic regression), and use standard inference methods.

Using latent intermediate variables has several advantages over supervised intermediate variables or direct prediction. Since system 100 can infer the intermediate variables automatically, they can represent concepts that are non-obvious to human designers. System 100 can optimize the overall accuracy with a tradeoff between predictive power of the intermediate variables and difficulty of their inference. Transaction data becomes a cheap and plentiful supervision signal. This improves the inference of intermediate variables. System 100 can learn better language or vision models by using this supervision signal.

Note that some currently available recommendation systems do not use transaction data to train intermediate variables. Instead, such systems train and infer the intermediate variables separately, and only use the results for recommendation. Other standard recommendation systems use transaction data as a replacement for proper training labels for intermediate variables. For example, suppose that one believes gender is a useful intermediate variable. Suppose further that one believes Movie 1 is watched mainly by males, and Movie 2 is watched mainly by females. It is common to substitute the proper male/female supervision labels with the Movie 1 or Movie 2 supervision labels. In contrast, the techniques disclosed herein allows for using the transaction data as a supervision signal, but does not require it to correspond directly to one of the intermediate variables.

### Applying the Recommender

FIG. 6 presents a flowchart illustrating an exemplary process for applying the recommender, according to an embodiment. After training the recommender, system 100 can apply the recommender to infer a cluster for a customer and generate one or more and recommendations.

Rather than assigning a customer based on only primary data (e.g., transaction data), system 100 also analyzes auxiliary social network data (e.g., photos) to assign a customer to a cluster. By analyzing auxiliary data when assigning clusters, system 100 can even assign customers to clusters even if there is limited or no transaction data or other primary data for the customer. Typically, system 100 can determine an appropriate cluster for a customer by picking the cluster that best “fits” or “explains” the data available for the customer (e.g., using the maximum likelihood cluster in a probabilistic system).

Initially, system 100 collects data (e.g., including both transaction and photo data) for a new or existing customer (operation 602). System 100 may collect the photo data from the customer's social networking profile and the transaction data from a merchant's server or other server storing transaction information. System 100 may also collect data from various data sources such as cell phones, multimedia messages, and other image and video sources.

System 100 then infers a cluster membership for the customer based on the data and cluster parameters (operation 604). In one implementation, system 100 can analyze the transaction and photo data to determine distributions of the data and/or generate histograms. For example, system 100 can determine that a customer has 40% outdoor photos, 40% traveling photos, and 20% bar photos. In some implementations, system 100 can also determine a distribution for a customer based on the customer's transaction data, such as the movies that the customer has watched in the past.

System 100 can assign the customer to one cluster, although some implementations may allow for assigning the customer to a set of clusters or to a distribution of clusters. The customer is associated with a vector of numbers that maps to a point in n-dimensional space. The vector of numbers represent the distribution and/or histogram of products and/or photos for the customer. System 100 can assign the point to a cluster. The cluster includes other points that represent other customers. In one embodiment, system 100 can assign customers to the same cluster when their respective points are within the parameters of the cluster. In some circumstances, a customer may not fall within the parameters of a single cluster, and system 100 may choose to assign the customer to a most probable cluster.

System 100 can then generate one or more recommendations and/or predictions based on the cluster membership and recommender parameters (operation 606). System 100 can generate recommendations based on the one or more clusters that a customer is assigned to. For example, system 100 may assign a customer to cluster 502. Six customers (e.g., represented by points 504A-504F) in cluster 502 have watched Die Hard, five customers (e.g., represented by points 504A-504E) have watched Aliens, and one customer (e.g., represented by point 504E) has watched The Godfather. The recommendation list for cluster 502 may include Die Hard as a top recommendation. System 100 may recommend Die Hard to the customer assigned to cluster 502. System 100 may also combine recommendations from different clusters for a customer that does not fall within the parameters of a single cluster. For example, system 100 may merge recommendations by weighing the recommendations according to their respective probabilities.

Note that system 100 can cluster customers based on transaction data alone without analyzing photos. For example, system 100 can predict that customers assigned to a cluster are likely to enjoy watching Die Hard or Aliens, and that they are less likely to enjoy watching The Godfather. However, by also including auxiliary data in the analysis, system 100 can improve the recommendations and predict whether customers will enjoy watching a movie (or other consumer activity) with a greater success rate.

### Exemplary System

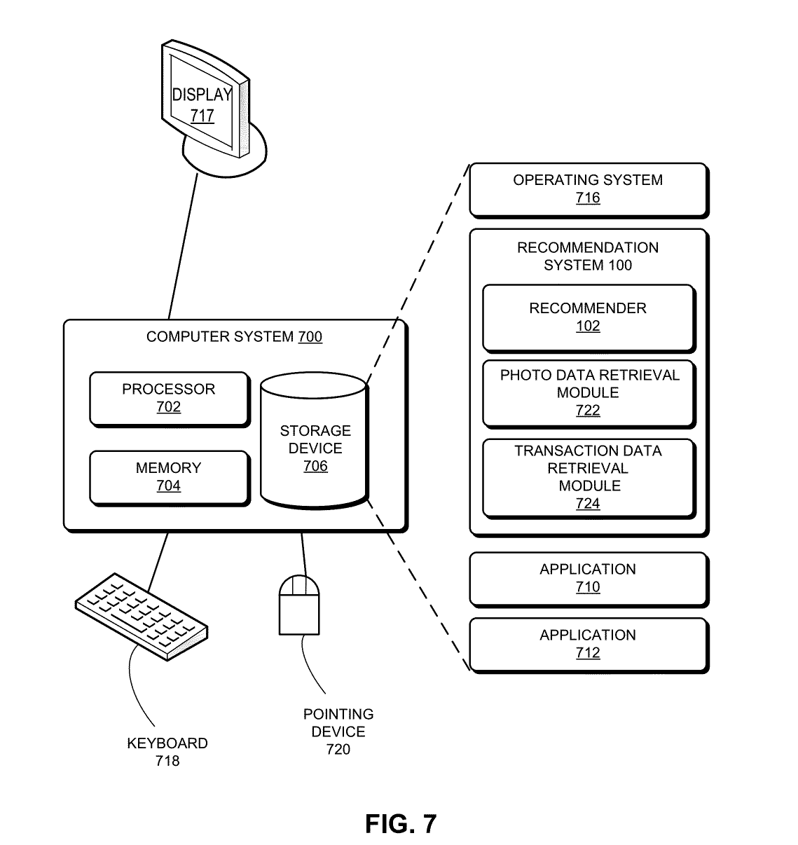

FIG. 7 illustrates an exemplary computer system that facilitates a recommender, in accordance with an embodiment. In one embodiment, computer system 700 includes a processor 702, a memory 704, and a storage device 706. Storage device 706 stores a number of applications, such as applications 710 and 712 and operating system 716. Storage device 706 also stores recommendation system 100, which may include recommender 102, photo data retrieval module 722, and transaction data retrieval module 724. During operation, one or more applications, such as recommender 102, are loaded from storage device 706 into memory 704 and then executed by processor 702. While executing the program, processor 702 performs the aforementioned functions. Computer and communication system 700 may be coupled to an optional display 717, keyboard 718, and pointing device 720.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for generating one or more recommendations for a customer, comprising:
obtaining transaction and image data for a plurality of existing customers;
training one or more parameters of conditioning variables associated with one or more clusters based on image data as part of a predictive model;
determining a list of recommendable items for each cluster, based on the transaction data;
obtaining transaction and image data for a customer;
determining that the customer is a member of a cluster associated with the predictive model, based on the obtained transaction and image data;
and
generating a recommendation for one or more recommendable items for the customer based on the determined cluster membership.

2. The method of claim 1, wherein determining that the customer is a member of a cluster comprises generating one or more intermediate variables; and predicting values of conditioning variables based on predicted values of the one or more intermediate variables.

3. The method of claim 1, further comprising generating a recommendation based on membership in a single cluster, based on membership in a set of clusters, or based on a probability distribution over clusters.

4. The method of claim 1, further comprising:
determining that a quantity of available transaction data for a new customer is below a predetermined threshold; and
responsive to the determination, obtaining image data for the customer to generate an item recommendation for the customer.

5. The method of claim 1, wherein the conditioning variables include one or more of product preference clusters, demographics-based clusters, activity preference clusters, or relationship-based clusters.

6. The method of claim 1, further comprising:
generating one or more intermediate variables from image data and/or other auxiliary data; and
training the intermediate variables with transaction data as a supervision signal.

7. The method of claim 1, wherein the predictive model includes at least one of:
generative decomposition of a joint distribution p(T, C, I, A)=p(C) p(I|C) p(A|I) p(T|C) such that the target variables are denoted by T, the conditioning variables are denoted by C, the intermediate variables are denoted by I, and the auxiliary data are denoted by A; or
discriminative decomposition of a joint distribution P(T, C, I, A)=p(A) p(I|A) p(C|I) p(T|C).

8. A computer-readable storage medium storing instructions that when executed by a computer cause the computer to perform a method for generating one or more recommendations for a customer, the method comprising:
obtaining transaction and image data for a plurality of existing customers;
training one or more parameters of conditioning variables associated with one or more clusters based on image data as part of a predictive model;
determining a list of recommendable items for each cluster, based on the transaction data;
obtaining transaction and image data for a customer;
determining that the customer is a member of a cluster associated with the predictive model, based on the obtained transaction and image data;
and
generating a recommendation for one or more recommendable items for the customer based on the determined cluster membership.

9. The computer-readable storage medium of claim 8, wherein determining that the customer is a member of a cluster comprises generating one or more intermediate variables; and predicting values of conditioning variables based on predicted values of the one or more intermediate variables.

10. The computer-readable storage medium of claim 8, further comprising generating a recommendation based on membership in a single cluster, based on membership in a set of clusters, or based on a probability distribution over clusters.

11. The computer-readable storage medium of claim 8, wherein the method further comprises:
determining that a quantity of available transaction data for a new customer is below a predetermined threshold; and
responsive to the determination, obtaining image data for the customer to generate an item recommendation for the customer.

12. The computer-readable storage medium of claim 8, wherein the conditioning variables include one or more of product preference clusters, demographics-based clusters, activity preference clusters, or relationship-based clusters.

13. The computer-readable storage medium of claim 8, wherein the method further comprises:
generating one or more intermediate variables from image data and/or other auxiliary data; and
training the intermediate variables with transaction data as a supervision signal.

14. The computer-readable storage medium of claim 8, wherein the predictive model includes at least one of:
generative decomposition of a joint distribution p(T, C, I, A)=p(C) p(I|C) p(A|I) p(T|C) such that the target variables are denoted by T, the conditioning variables are denoted by C, the intermediate variables are denoted by I, and the auxiliary data are denoted by A; or
discriminative decomposition of a joint distribution P(T, C, I, A)=p(A) p(I|A) p(C|I) p(T|C).

15. A computing system for generating one or more recommendations for a customer, the system comprising:
one or more processors,
a computer-readable medium coupled to the one or more processors having instructions stored thereon that, when executed by the one or more processors, cause the one or more processors to perform operations comprising:
obtaining transaction and image data for a plurality of existing customers;
training one or more parameters of conditioning variables associated with one or more clusters based on image data as part of a predictive model;
determining a list of recommendable items for each cluster, based on the transaction data;
obtaining transaction and image data for a customer;
determining that the customer is a member of a cluster associated with the predictive model, based on the obtained transaction and image data;
and
generating a recommendation for one or more recommendable items for the customer based on the determined cluster membership.

16. The computing system of claim 15, wherein determining that the customer is a member of a cluster comprises generating one or more intermediate variables; and predicting values of conditioning variables based on predicted values of the one or more intermediate variables.

17. The computing system of claim 15, wherein the operations further comprises generating a recommendation based on membership in a single cluster, based on membership in a set of clusters, or based on a probability distribution over clusters.

18. The computing system of claim 15, wherein the operations further comprises:
determining that a quantity of available transaction data for a new customer is below a predetermined threshold; and
responsive to the determination, obtaining image data for the customer to generate an item recommendation for the customer.

19. The computing system claim 15, wherein the conditioning variables include one or more of product preference clusters, demographics-based clusters, activity preference clusters, or relationship-based clusters.

20. The computing system of claim 15, generating one or more intermediate variables from image data and/or other auxiliary data; and
training the intermediate variables with transaction data as a supervision signal.

21. The computing system of claim 15, wherein the predictive model includes at least one of:
generative decomposition of a joint distribution p(T, C, I, A)=p(C) p(I|C) p(A|I) p(T|C) such that the target variables are denoted by T, the conditioning variables are denoted by C, the intermediate variables are denoted by I, and the auxiliary data are denoted by A; or
discriminative decomposition of a joint distribution P(T, C, I, A)=p(A) p(I|A) p(C|I) p(T|C).
